(19) United States
(12) Patent Application Publication
(10) Pub. No.: US 2007/0107495 A1
(43) Pub. Date: May 17, 2007

(54) Particle adsorption chamber, sampling apparatus having a particle adsorption chamber, and sampling method using the same

(76) Inventors: Dong-Hyun Kim, Osan-si (KR); Bok-Seok Yang, Hwaseong-si (KR); Do-Hyun Cho, Yongin-si (KR); Hwan-Ki Choi, Hwaseong-gun (KR); Jung-Hee Na, Yongin-si (KR); Gung-Hang Ryu, Yongin-si (KR)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 11/595,976

(22) Filed: Nov. 13, 2006

(30) Foreign Application Priority Data
Nov. 14, 2005 (KR) 2005-108703

(51) Int. Cl. G01N 19/10; G01N 1/22

(52) U.S. Cl. 73/31.02; 73/863.21

(57) ABSTRACT

A particle adsorption device includes a chamber having an inlet and an outlet by which air can pass through the chamber, a support for supporting an adsorbent plate in the chamber, and at least one porous plate disposed in the chamber to control the air flow through the chamber and over a surface of the adsorbent plate. A sampling apparatus includes a particle counter which has a detector that is operative to count particles of a certain size contained in the air, the particle adsorption device, and a probe by which a sample of air is sequentially or selectively fed to the particle adsorption device and the particle counter. Thus, in a method for use in monitoring a manufacturing environment for potential contamination, particles of a certain size in the air can be counted, and particles in the air can be collected on the surface of the adsorbent plate. The collected particles can be analyzed to determine their shape and composition. Te source of the particles can be traced from data produced using the sampling apparatus.

### BACKGROUND OF THE INVENTION

1. Field of the Invention

The present invention relates to a sampling method of and apparatus for analyzing an environment for its particle content. More particularly, the present invention relates to methods of and apparatus for detecting particles as potential contaminants in an environment in which a certain level of cleanness is to be maintained, such as in a clean room of a semiconductor device manufacturing facility.

2. Description of the Related Art

A semiconductor device is an extremely elaborate device fabricated by repeatedly performing a plurality of processes including photolithography, diffusion, etching, and deposition processes on a semiconductor wafer. These processes must be carried out precisely, i.e., under strict process conditions, and in an environment having a high level of cleanness. Otherwise, particles will contaminate the semiconductor wafer and cause defects to occur.

A surface particle counter or air particle counter is generally used to maintain a proper state of cleanness in a semiconductor device fabrication facility. The surface particle counter or air particle counter collects a sample of air using a pump, e.g., a GAST pump, and counts the number of particles in the sample of the air. In particular, the surface particle counter blows air onto a surface which has been exposed in the facility and suctions the air rebounding from the surface using the pump, whereas the air particle counter only suctions air in the facility using the-pump. The results obtained from the surface particle counter or air particle are used to schedule maintenance or otherwise monitor the facility for contamination.

FIG. 1 illustrates a conventional surface particle counter 10. The surface particle counter 10 includes a housing 18 in which an exhaust fan 17 is installed, and a pump 11, e.g., a GAST pump, disposed inside the housing 18. A probe 15 is connected to both the intake and exhaust sides of the pump 11 to blow air onto and suction air from a surface of an object 50 that has come from the semiconductor device fabrication facility. The arrows in the figure indicate the direction of air flow through the surface particle counter 10. A particle detector 16 measures the size and number of particles contained in air introduced thereto through the probe 15. Air that has passed through the particle detector 16 is filtered and purified by a first filter 13, e.g., a DUST filter, and a second filter 14, e.g., a ZERO filter. The purified air is blown back outside the housing 18 through the probe 15. A flow control valve 12 controls the flow of air through the filters 13, 14 and back out the probe 15.

FIG. 2 is a flowchart illustrating the operation of the conventional surface particle counter 10. Referring to FIGS. 1 and 2, the pump 11 begins to operate when power is supplied to the surface particle counter 10 (S11). As a result, air is blown out of and suctioned back through the probe 15 (S15). The flow rate of the exhaust (air blown out of the probe 15) is controlled by the flow control valve 12 (S12). Particles are separated from a surface of the object 50 by the exhaust (S15a). Air containing the particles separated from the object 50 is sucked back into the probe 15 by the pump 11 (S15b). The air induced into the probe 15 by suction is introduced into the particle detector 16 where the number of particles contained in the air is counted (S16). Air that has passed through the particle detector 16 flows back through the pump 11 and is exhausted at a rate controlled, again, by the flow control valve 12 (S12). Relatively large particles are removed from the air by the first filter 13 (first filtering S13), and then relatively small particles are removed from the air by the second filter 14 (second filtering S14).

Similar to the conventional surface particle counter, a conventional air particle counter suctions air through a probe and measures the number of particles contained in the air using a particle detector. However, in this case the air is a sample of the environment in which the fabrication process is being carried out.

As described above, the conventional surface particle counter samples air blown onto an object exposed to an environment in which a semiconductor device is fabricated. A conventional air particle counter samples air directly from the environment itself. Each of the conventional particle counters employs a particle detector to count numbers of particles of certain sizes. The results are used to maintain and manage the cleanness of the environment in which the semiconductor devices are being fabricated.

However, the conventional particle counters merely provide numerical results regarding the sizes of particles in the collected samples. That is, conventional particle counters do not provide a determination of the composition, shape, or cause of particles in the air.

### SUMMARY OF THE INVENTION

Objects of the present invention are to provide a device, an apparatus and a method by which the source or cause of particles in a manufacturing environment or the like can be determined with a high degree of reliability.

According to one aspect of the present invention, a particle adsorption device includes a chamber, an adsorption plate, a support disposed inside the chamber and configured to support the adsorption plate, and at least one porous plate disposed in an air flow path within the chamber. The chamber has an inlet and an outlet through which air can pass into and out of the chamber along the air flow path. A surface of the adsorption plate is exposed to air entering the chamber through the inlet. Thus, a surface of the adsorption plate will adsorb the air and thereby trap particles contained in the air on the surface. Pores of the at least one porous plate are arranged to stabilize air introduced into the chamber through the inlet at a given rate.

The at least one porous plate may include a first porous plate disposed to one side of the adsorption plate and a second porous plate disposed to the other side of the adsorption plate. In addition, a third porous plate may be disposed on an opposite side of the first porous plate from the adsorption plate. In this case, pores of the third porous plate are arranged to distribute air entering the inlet of the chamber such that the air is not concentrated on a predetermined region of the adsorption plate. In particular, the pores of the third porous plate include a plurality of first through-holes and a plurality of second through-holes. The first through-holes are concentrated at a central portion of the third porous plate and have a diameter smaller than that of the second through-holes.

The chamber of the particle adsorption device may include a chamber body having a respective opening in an upper and/or a lower portion thereof, and a respective cover sealing each opening. The cover includes a projection extending into the chamber body. The projection has a frustum-shaped concavity therein constituting a portion of the air flow path within the chamber.

According to another aspect of the present invention, the particle adsorption device is integrated with a particle detector to form a sampling apparatus. According to this aspect of the present invention, air lines connect the chamber of the particle adsorption device to the particle detector of the particle counter.

According to still another aspect of the present invention, the sampling apparatus also includes a pump having an intake side at which the pump creates a vacuum and an exhaust side at which air is forced from the pump, and a probe. In this case, the air lines which connect the chamber of the particle adsorption device to the particle detector are part of a system of lines that include an exhaust line extending from the exhaust side of the pump, and a vacuum line leading to the vacuum side of the pump. The probe is connected to the vacuum line at an end of the vacuum line. Thus, air can be sucked into the vacuum line through the probe when the pump is running.

The particle detector and the chamber of the particle adsorption device may be disposed in series in the vacuum line between the probe and the intake side of the pump. Alternatively, the vacuum line has a first branch, and a second branch extending from the probe. The first and second branches diverge between the probe and the inlet of the chamber of the particle adsorption device. The particle counter is disposed at the end of the second branch of the vacuum line. Several flow directional control valves may be provided in the lines to control the direction of flow of air through the lines.

For instance, a first directional flow control valve is disposed in the vacuum line between the outlet of the chamber of the particle adsorption device and the intake side of the pump, and a second directional flow control valve is disposed in the vacuum line at the location at which the first and second branches of the vacuum line diverge. In addition, a third flow directional control valve may be disposed in the first branch of the vacuum line. Each of the valves may be a 3-way solenoid valve. Filters may be connected to the vacuum line through the second and third flow directional control valves, respectively. Another filter may be provided in the exhaust line.

According to another aspect of the present invention, a sampling method includes collecting a sample of air using suction, detecting particles of a certain size in the sample of air and counting the number of particles, and adsorbing air from the sample by passing the air over an adsorbent medium to thereby trap particles in the air on a surface of the medium. The particles trapped on the surface of the medium can then be analyzed to determine, for example, their shape and composition.

According to still another aspect of the present invention, a sampling method includes drawing air into and through a probe, directing air that is drawn through the probe to a particle counter that detects particles of a certain size and counts the number of particles, and directing air that is drawn through the probe over the surface of an adsorbent medium supported in a hermetic chamber of a particle adsorption device. The air is adsorbed by the medium to trap particles suspended in the air on the surface of the medium.

The air is drawn in through the probe by a vacuum created using a pump. The air drawn in through the probe may be directed sequentially from one of the chamber of the particle detection device and the particle detector to the other. Alternatively, air drawn in through the probe is selectively directed to the chamber of the particle detection device and the particle detector. In the latter case, air may be drawn into the particle detector of the particle counter using a pump of the particle counter while air is being directed from the probe to the chamber of the particle detection device.

Also, air may be blown out through the probe and onto the surface of an object using a pump while air is being drawn into the probe using the pump. The air blown out of the probe is used to dislodge particles from the surface of the object. The air may be purified before it is blown out through the probe.

Finally, the adsorbent medium may be removed from the hermetic chamber so that the particles trapped on the surface of the medium can be analyzed.

### BRIEF DESCRIPTION OF THE DRAWINGS

These and other objects, features and advantages of the present invention will become more apparent from the following detailed description of the preferred embodiments of the invention made with reference to the accompanying drawings. In the drawings:

FIG. 1 is a schematic diagram of a conventional sampling apparatus;

FIG. 2 is a flowchart of the operation of the conventional sampling apparatus;

FIG. 3 is a schematic diagram of a first embodiment of a particle sampling apparatus according to the present invention;

FIG. 4 is a flowchart of a first embodiment of a sampling method for use in analyzing an environment according to the present invention;

FIG. 5 is a schematic diagram of a second embodiment of a particle sampling apparatus according to the present invention;

FIG. 6 is a flowchart of a second embodiment of a sampling method for use in analyzing an environment according to the present invention;

FIG. 7 is a perspective view of an adsorption device of the first embodiment of a particle sampling apparatus according to the present invention;

FIG. 8 is an exploded perspective view of the adsorption device;

FIG. 9 is a plan view of a porous plate of the adsorption device;

FIG. 10 is a plan view of another porous plate of the adsorption device;

FIG. 11 is a perspective view of a chamber cover of the adsorption device;

FIG. 12 is a cross-sectional view of the chamber cover;

FIG. 13 is a schematic diagram of a third embodiment of a sampling apparatus according to the present invention;

FIG. 14 is a schematic diagram of the third embodiment of the sampling apparatus according to the present invention while in a particle detection mode;

FIG. 15 is a flowchart of the particle detection mode of the third embodiment of the sampling apparatus in according to the present invention;

FIG. 16 is a schematic diagram of the third embodiment of the sampling apparatus according to the present invention while in a particle adsorption mode; and

FIG. 17 is a flowchart of the particle adsorption mode of the third embodiment of the sampling apparatus according to the present invention.

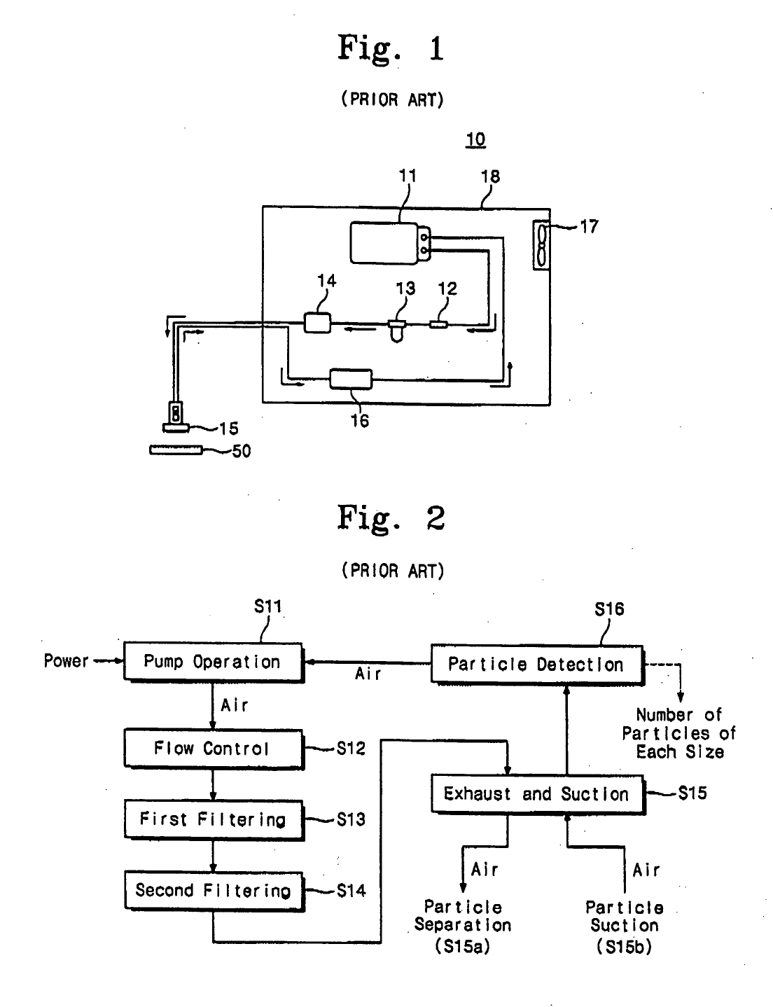

### DETAILED DESCRIPTION OF THE PREFERRED EMBODIMENTS

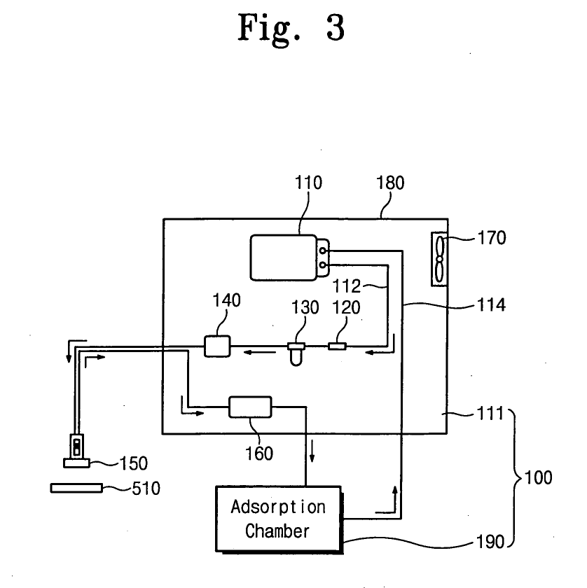

Referring to FIG. 3, a first embodiment of a particle sampling apparatus 100 includes a particle counter 111 and an adsorption device 190 coupled to the particle counter 111. The particle counter 111 determines the sizes of particles entrained in a sample of air and counts the number of particles of each size, and the adsorption device 190 is used to determine the shape, composition, and source of the particles.

The particle counter 111 includes a pump 110 having an exhaust side at which pressure is created and an intake side at which a vacuum is created, a flow control valve 120, a first filter 130 and a second filter 140 disposed in-line with the pump 110 at the exhaust side of the pump 110, a probe 150 connected to both the exhaust side and the intake side of the pump 110, and a particle detector 160 disposed in-line with the pump 110 at the intake side of the pump 110. The pump 110 is a GAST pump, for example. The pump 110 is disposed inside a housing 180. An exhaust fan 170 is mounted to the housing 180.

More specifically, an exhaust line 112 extends from the exhaust side of the pump 110, and a vacuum line 114 leads to the intake side of the pump 110. The probe 150 is connected to respective ends of the lines 112 and 114 so that air flowing through the exhaust line 112 is blown out of the probe 150 and air outside the probe 150 is induced into the vacuum line 114 though the probe 150. The probe 150 may be positioned to face an object 510 such that air blown out of the probe impinges the object 510 to dislodge particles from the object, and such that air containing the particles is sucked into the probe 150. The object 510 may be one that is exposed within a fabrication facility, e.g., a clean room of a semiconductor device manufacturing facility. Alternatively, the probe 150 is disposed in the fabrication facility to merely collect a sample of air from the environment within the facility. In the latter case, the end of the exhaust line 112 leading to the probe 150 can be omitted.

The flow control valve 120 controls the flow of air through the exhaust line 112, i.e., regulates the rate of flow of the air. The first filter 130 is for filtering out relatively large foreign particles from the air flowing through the exhaust line 112. The first filter 130 is a DUST filter, for example. The second filter 140 is for filtering out relatively small foreign particles in the air flowing through the exhaust line 112. The second filter 140 is a ZERO filter, for example.

Particles in the air induced into the vacuum line 114 through the probe 150 flow along with the air to the particle detector 160. The particle detector 160 determines the sizes of particles entrained in the air taken in through the probe 150 and counts the number of particles of each size. In this respect, the particle detector 160 is conventional per se and thus, a detailed description thereof will be omitted. Also, note, counting the number of particles of “each size” can refer to counting. particles whose diameters are within given numerical ranges.

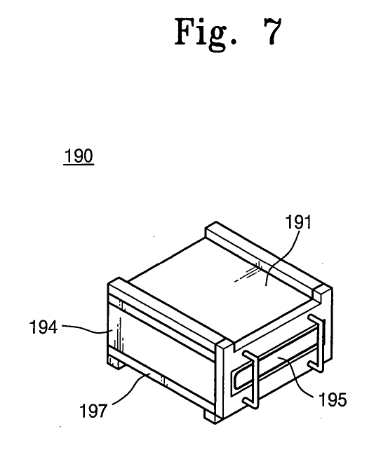

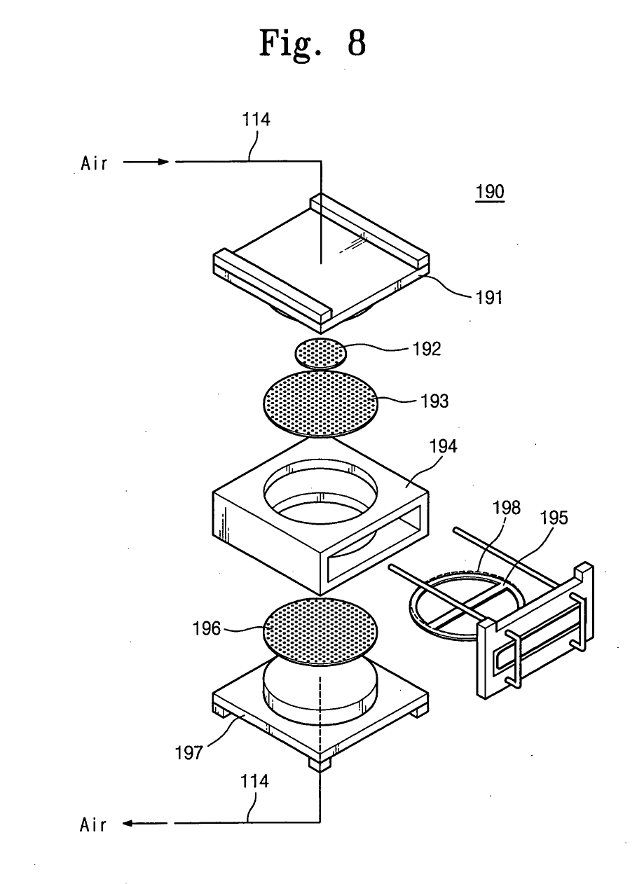

The adsorption device 190 is disposed in-line with the pump 110 of the particle counter 111 at the intake side of the pump 110. Specifically, the adsorption device 190 is disposed in the vacuum line 114 downstream of the particle detector 160 with respect to the direction of flow of the air through the vacuum line 114. Thus, particles in the air induced into the vacuum line 114 through the probe 150 flow along with the air to the adsorption device 190 after having passed through the particle detector 160. The adsorption device 190 will now be described in more detail with reference to FIGS. 7 and 8.

The adsorption device 190 has a hermetic chamber formed of a chamber body 194, an upper chamber cover 191 and a lower chamber cover 197. The chamber body 194 has (circular) openings in an upper portion and a lower portion thereof and a door at one side thereof. The upper chamber cover 191 and lower chamber cover 197 are fitted to the openings in the upper portion and a lower portion of the chamber body 194, respectively, to cover the chamber body 194. A chuck (support) 195 is inserted in the chamber body 194. The adsorption chamber 190 also has an adsorption plate 198 supported by the chuck 195 within the chamber body 194. The adsorption plate 198 can be a bare wafer but is not limited thereto. Any medium that can adsorb air can be used for the adsorption-plate 198. The adsorption plate 198 can be removed from the chamber body 194 through the door thereof. Specifically, the opening in the side of the chamber body closed by the door is wider than that of the adsorption plate 198. Thus, the adsorption plate 198 can be removed from the chamber body 194 so that particles trapped on the surface of the adsorption plate 198 can be analyzed outside the chamber body 194.

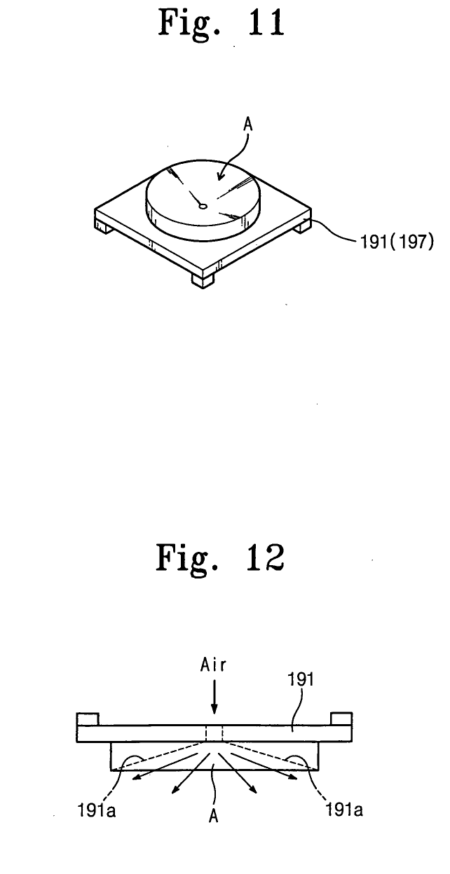

Air flowing through the vacuum line 114 passes into the chamber body 194 through an inlet (FIGS. 11, 12) in the upper chamber cover 191. The air is adsorbed by a surface of the adsorption plate 198 within the chamber body 194 so that particles contained in the air are trapped. The remaining (non-adsorbed) air passes back into the vacuum line 114 through an outlet (FIGS. 11, 12) in the lower chamber cover 197, and flows to the pump 110. A vacuum is maintained inside the chamber body 194 by the pump 110.

In addition, the adsorption chamber 190 includes porous plates inside the chamber body 140. More specifically, the plates include a first upper porous plate 192 and a second upper porous plate 193 disposed above the adsorption plate 198, and a lower porous plate 196 disposed below the adsorption plate 198. The porous plates 193, 196 stabilize the flow of air through the adsorption chamber 190. The porous plate 192 prevents a concentration of particles from being adsorbed at a particular region of the adsorption plate 198. The porous plates 192, 193 and 196 can be supported and spaced apart from one another within the chamber body 194 by any suitable fixtures/spacers.

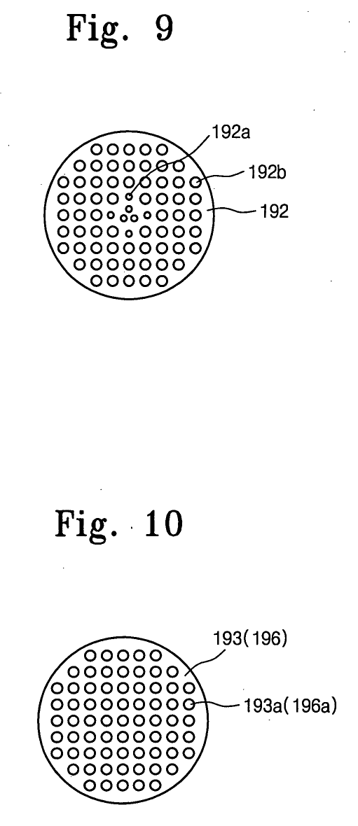

Referring to FIG. 9, the first upper porous plate 192 includes a plurality of through-holes (pores) 192a each having a relatively small diameter and a plurality of through-holes (pores) 192b each having a relatively large diameter. The holes 192a are concentrated in a central portion of the first upper porous plate 192 to prevent air introduced through the upper cover 191 from being concentrated at a central portion of the adsorption plate 198. The size and number of the holes 192a and 192b depend on the size of the adsorption plate 198, the flow rate of the air through the adsorption chamber 190, etc. When the adsorption plate 198 is an 8-inch bare wafer and the air is regulated to flow at a rate of about 1 CFM (cubic feet per minute), for example, the holes 192a have a diameter of about 5 mm and the holes 192b have a diameter of about 10 mm.

Referring to FIG. 10, the second upper porous plate 193 has a plurality of holes (pores) 193a each having a predetermined diameter and which are uniformly distributed across the plate 193. Like the second upper porous plate 193, the lower porous plate 196 has a plurality of holes 196a each having a predetermined diameter and which are uniformly distributed across the plate 196. The size and number of the holes 193a, 196a depend on the flow rate of the air, etc. The holes 193a, 196a each have a diameter of about 5 mm when the flow rate of the air through the adsorption chamber 190 is about 1 CFM, example. The lower porous plate 196 minimizes the swirling or back flow of air that is introduced after particles are adsorbed by the adsorption plate 198.

Referring to FIGS. 11 and 12, the upper chamber cover 191 has a (circular) projection having a concavity in the form of a frustum A contiguous with the inlet. The projection is fitted to the chamber body 194 within the opening in the upper portion thereof to seal the opening. The concavity is defined by an inclined inner wall 191a. The diameter of the concavity increases in a direction away from the inlet. Air introduced through the inlet in the upper chamber cover 191 flows along the inclined inner wall 191a such that the air is guided over a wide area. Therefore, the upper chamber cover 191 facilitates the forming of a uniform air flow within the adsorption device 190. The lower chamber cover 197 may also have a (circular) projection fitted to the opening in the lower portion of the chamber body 194, an inclined inner wall 191a of the projection defining a concavity in the form of a frustum A contiguous with the outlet in the lower chamber cover 197, as indicated in FIG. 11.

Referring back to FIG. 3, the air flows into the exhaust line 112 via the pump 110 after having passed through the particle detector 160 and the adsorption chamber 190. There the air passes through the first filter 130 and the second filter 140 so as to be purified. The purified air is then blown out through the probe 150 onto the surface of object 510 or into the environment. At the same time, air is induced into the vacuum line 114 through the probe 150. During this time, the flow control valve 120 controls the rate at which the air is blown out of the probe 150. The present invention samples the environment directly or indirectly (via an object 510 exposed to the environment) through the continuous action of blowing air out of and suctioning air into the probe.

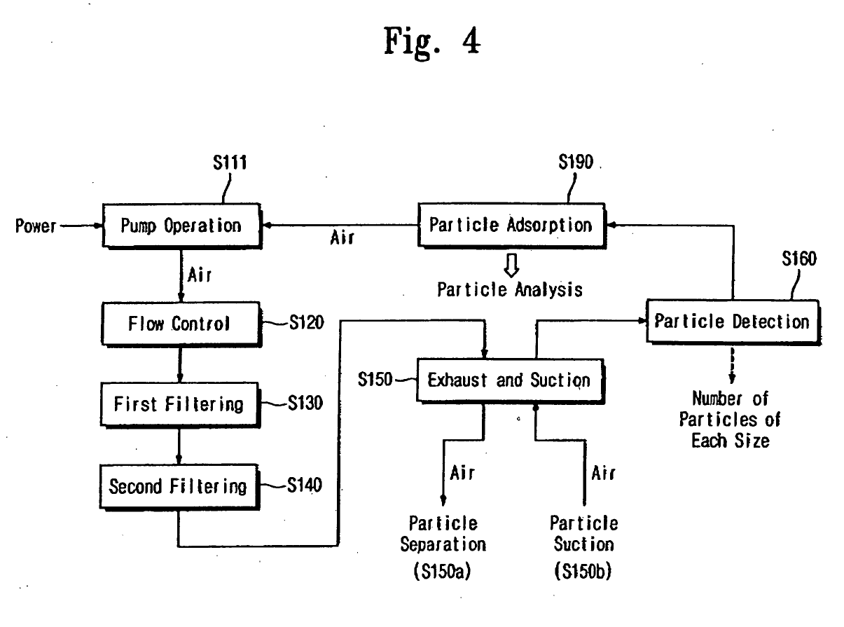

A sampling method according to the present invention will be described with reference to FIGS. 3 and 4.

Referring to FIG. 4, power is supplied to the sampling apparatus 100 to start the pump 110 (S111). As a result, air is blown out of and sucked back into the probe 150 (S150). The rate at which the air flows out of the probe 150 is controlled by the flow control valve 120 (S120). Also, relatively large particles are filtered from the air by the first filter 130 (S130), and then relatively small particles are secondly filtered from the air by the second filter 140 (S140) before the air reaches the probe 150.

Air blown out of the probe 150 dislodges particles from a surface of the object 510 (S150a). Alternatively, the probe may be located in a facility whose air is to be monitored directly. In either case, air containing particles is sucked into the probe 150 by the vacuum created by the pump 110 (S150b). The air sucked into the probe 150 is then introduced to the particle detector 160, where data indicating the sizes and the number of particles of each size is produced (S160). Air that has passed through the particle detector 160 is introduced into the adsorption chamber 190. Therefore, particles contained in the air are adsorbed by a surface of the adsorption plate 198 (S190). Then, the adsorption plate 198 is scanned by an apparatus such as a conventional process defect detection measurement apparatus, a scanning electron microscope (SEM), or a SEM equipped with an X-ray analyzer for producing data indicative of the shape and/or composition of particles trapped on the adsorption plate 198. The data can be analyzed to reveal the source or cause of the particles. Air that has passed through the adsorption chamber 190 is regulated to flow at a given rate (S120), is filtered (S130, S140), and is blown back out of the probe 150 (S150). At the same time, air containing particles is being sucked into the probe 150 (S150).

As described above, exhaust and suction processes (S150) are carried out continuously and simultaneously to sample particles from a surface of the object 510 or in the air of a manufacturing environment. The sampling is used to obtain data of the size and number of particles of each size. At the same time, particles are collected and can be analyzed to obtain data on the shape and/or composition of the particles. As a result, the source or cause of the particles can be pin-pointed.

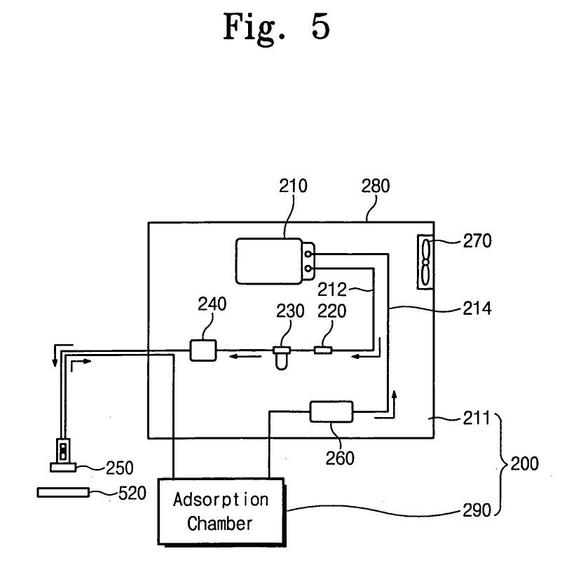

FIG. 5 illustrates a second embodiment of a sampling apparatus 200 according to the present invention. Referring to FIG. 5, the second embodiment of the sampling apparatus 200 includes a particle counter 211 and an adsorption device coupled to the particle counter 211. The particle counter 211 includes a pump 210 having an exhaust side at which pressure is created and an intake side at which a vacuum is created, a flow control valve 220, a first filter 230 and a second filter 240 disposed in-line with the pump 210 at the exhaust side of the pump 210, a probe 250 connected to both the exhaust side and the intake side of the pump 210, and a particle detector 260 disposed in-line with the pump 210 at the intake side of the pump 210. The pump 210 is a GAST pump, for example. The pump 210 is disposed inside a housing 280. An exhaust fan 270 is mounted to the housing 180.

An exhaust line 212 extends from the exhaust side of the pump 210, and a vacuum line 214 leads to the intake side of the pump 210. The probe 250 is connected to respective ends of the lines 212 and 214 so that air flowing through the exhaust line 212 is blown out of the probe 250 and air outside the probe 250 is induced into the vacuum line 214 though the probe 250. The probe 250 may be positioned to face an object 520 such that air blown out of the probe impinges the object 520 to dislodge particles from the object, and such that air containing the particles is sucked into the probe 250. The object 520 may be one that is exposed within a fabrication facility, e.g., a clean room of a semiconductor device manufacturing facility. Alternatively, the probe 250 is disposed in the fabrication facility to merely collect a sample of air from the environment within the facility. In the latter case, the end of the exhaust line 212 leading to the probe 250 can be omitted.

The structure and function of the adsorption device 290 are the same as those shown in and described with reference to FIGS. 9 to 12. The sampling apparatus 200 is essentially the same as that of the first embodiment except that the adsorption chamber 290 is disposed upstream of the particle detector 260 with respect to the direction of flow of air through the vacuum line 214.

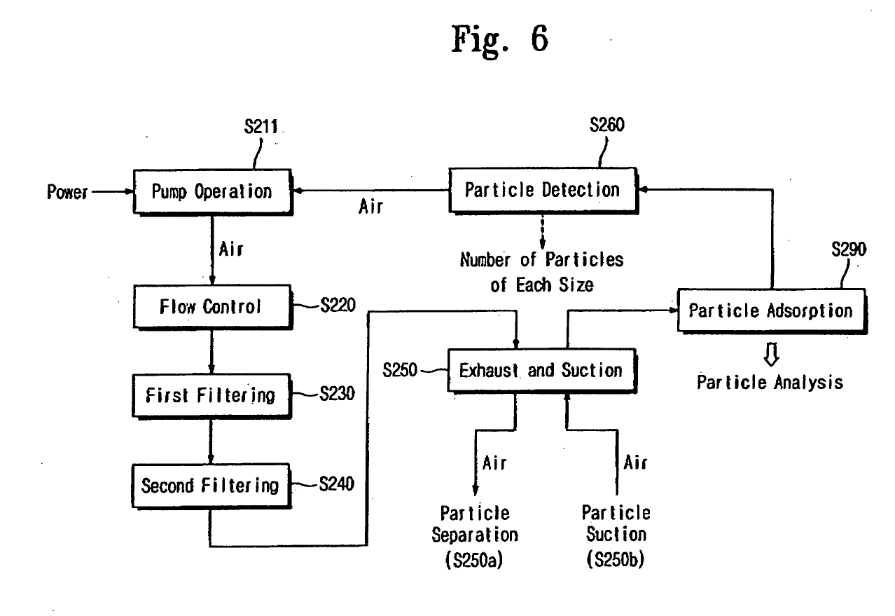

Referring to FIGS. 5 and 6, power is supplied to the sampling apparatus 200 to start the pump 210 (S211). As a result, air is blown out of and sucked back into the probe 250 (S250). The rate at which the air flows out of the probe 250 is controlled by the flow control valve 220 (S220). Also, relatively large particles are filtered from the air by the first filter 230 (S230), and then relatively small particles are secondly filtered from the air by the second filter 240 (S240) before the air reaches the probe 250.

Air blown out of the probe 250 separates particles from a surface of the object 520 (S250a). Alternatively, the probe may be located in a facility whose air is to be monitored directly. In either case, air containing particles is sucked into the probe 250 by the vacuum created by the pump 210 (S250b). The air sucked into the probe 250 is then introduced to the chamber of the adsorption device 290. Therefore, air is adsorbed by a surface of the adsorption plate (S290) to trap particles contained in the air on the surface. Then, an apparatus such as a conventional process defect detection measurement apparatus, a scanning electron microscope (SEM), or a SEM equipped with an X-ray analyzer is used for examining the particles on the adsorption plate to produce data indicative of the shape and/or composition of the particles.

Air that has passed through the adsorption device 290 is then introduced to the particle detector 260, where data indicating the sizes and the number of particles of each size is produced (S260). However, in this case, an analysis of the data produced by the particle detector 260 will take into account that many of the particles from the sample have been trapped in the adsorption device 290. Air that has passed through the particle detector 260 is regulated to flow at a given rate (S220), is filtered (S230, S240), and is blown back out of the probe 250 (S250). At the same time, air containing particles is being sucked into the probe 250 (S250).

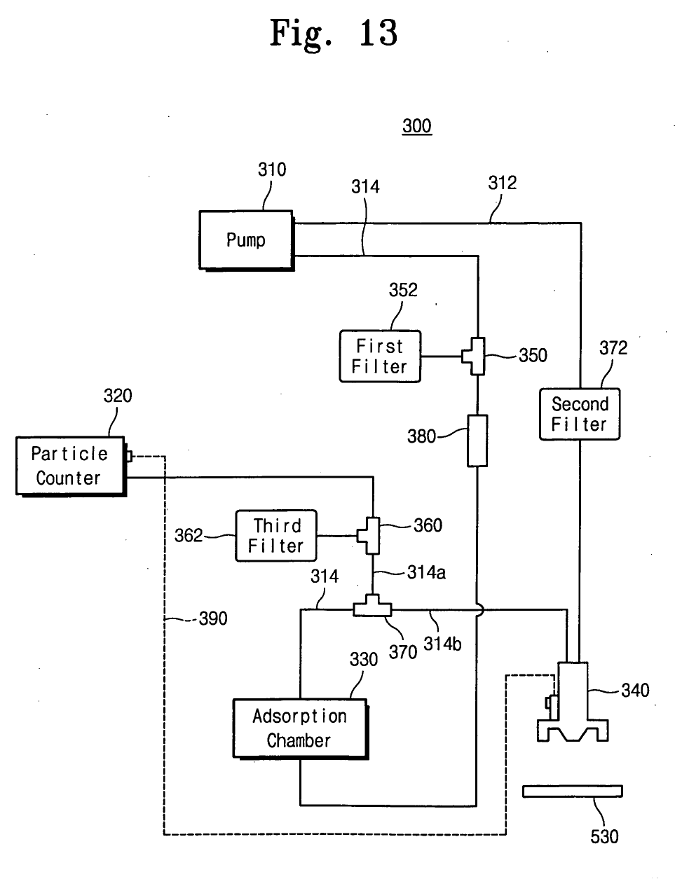

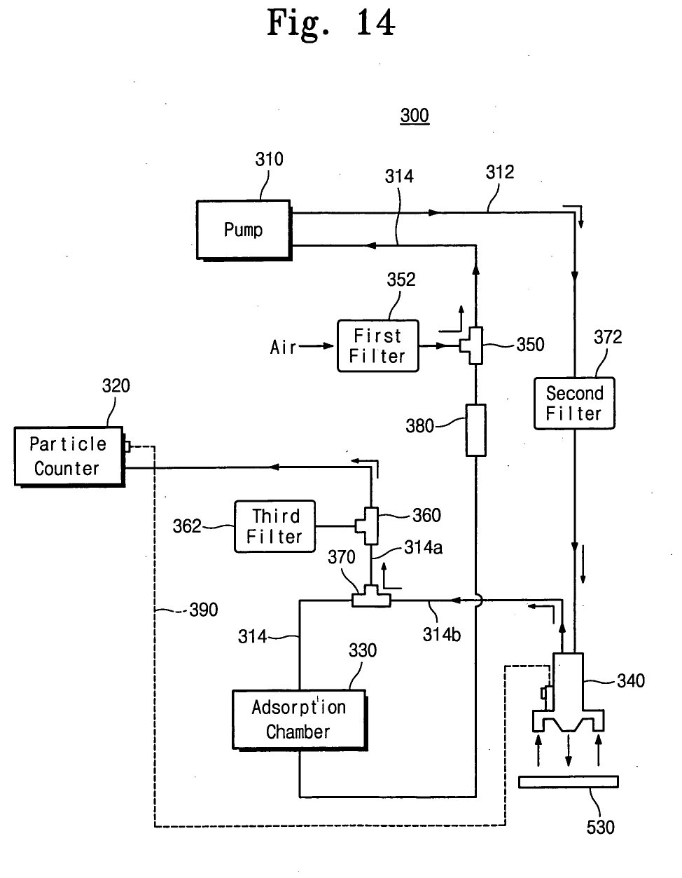

A third embodiment of a sampling apparatus 300 according to the present invention will now be described with reference to FIG. 13. A pump 310, e.g., a GAST pump, has an exhaust side, and an intake side. An exhaust line 312 and a vacuum line 314 extend from and lead to the intake and exhaust sides of the pump 310, respectively. A probe 340 is connected to respective ends of these lines 312 and 314. The probe 340 blows air onto an object 530 (or into a manufacturing environment) and sucks air from the object 530 (or environment).

A filter 372 (referred to hereinafter as the second filter) for filtering air is installed in the exhaust line 312. A first flow directional control valve 350, an adsorption device 330, and a second flow directional control valve 370 are disposed in series in the vacuum line 314. The first flow directional control valve 350 is connected to a filter 352 (referred to hereinafter as the first filter).

The vacuum line 314 is divided at the second flow directional control valve 370 into first and second branches 314a and 314b. The adsorption device 330, whose structure is the same as that of the adsorption chamber 190 of the first embodiment, is disposed in the vacuum line 314 downstream of the second flow directional control valve 370 with respect to the direction of flow of air through the vacuum line 314. A particle counter 320 having a particle detector is connected to one end of the first branch 314a of the vacuum line 314, and the probe 340 is connected to one end of the second branch 314b of the vacuum line 314. A third flow directional control valve 360 is disposed in the 314a second branch 314b of the vacuum line 314, and a filter 362 (referred to hereinafter as the third filter) is connected to the third flow directional control valve 360. Each of the flow directional control valves 350, 360 and 370 is a 3-way solenoid valve. Additionally, a flow meter 380 can be connected to the vacuum line 314.

The particle counter 320 is electrically connected to the probe 340 through a cable 390. Alternatively, the electrical connection between the particle counter 320 and the probe 340 can be a wireless connection. In either case, the probe 340 controls the operation of the particle counter 320. For example, the particle counter 320 is turned on by the probe 340 when the probe 340 is operating, i.e., while air is flowing through the probe. Likewise, the particle counter 320 is turned off when the probe 340 stops operating. Also, the particle counter 320 can have a built-in pump (not shown) to induce air into the particle detector from the first branch 314a of the vacuum line 314. The particle counter 320 is conventional, per se.

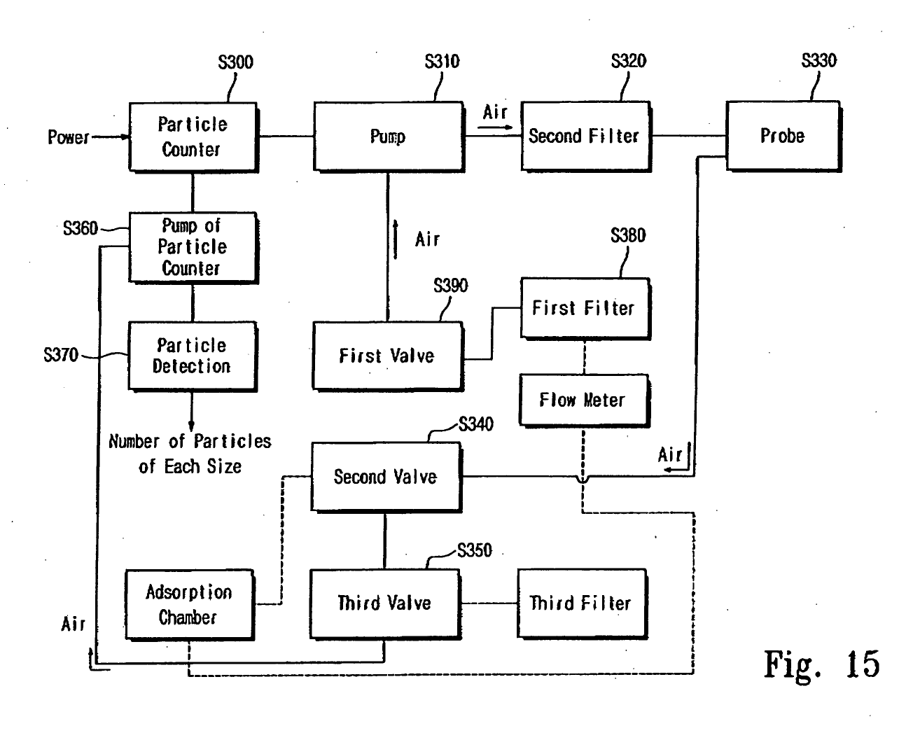

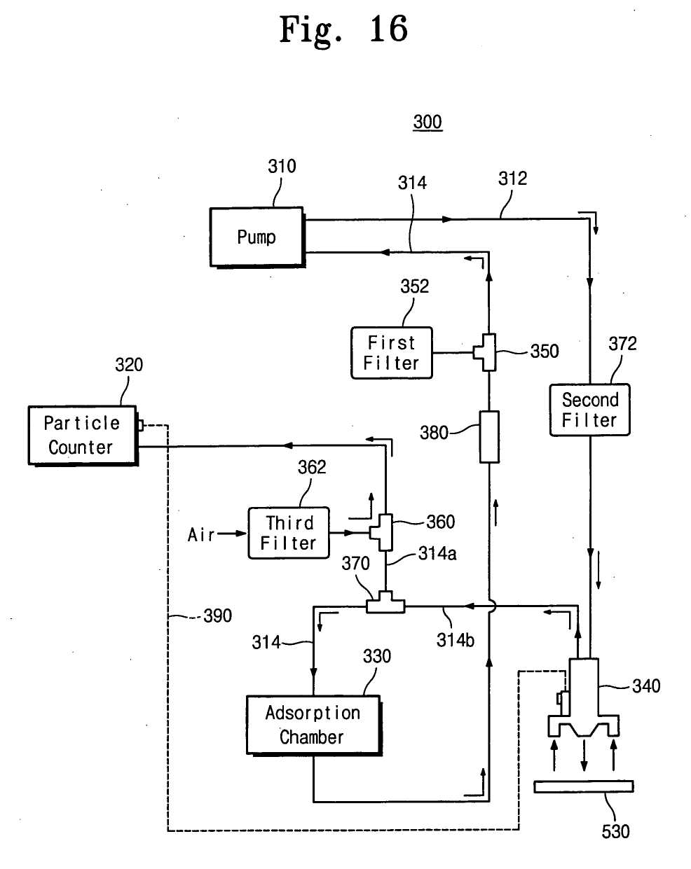

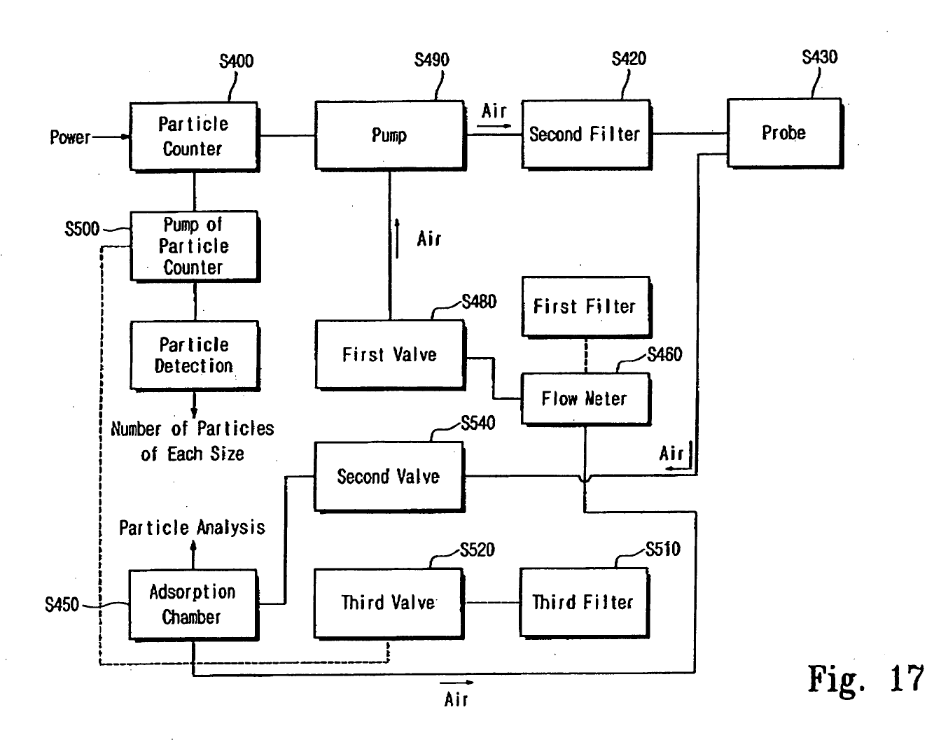

The particle sampling apparatus 300 can be operated in a particle detection mode or a particle adsorption mode. In the particle detection mode, the particle counter 320 is used. In the particle adsorption mode, the adsorption chamber 330 is used. The particle detection mode will be described below in detail with reference to FIGS. 14 and 15, and the particle adsorption mode will be described below in detail with reference to FIGS. 16 and 17.

Referring to FIG. 14, in the particle detection mode, the first directional flow control valve 350 is set to a first position “ [symbol] ”. Air flows from the first filter 352 to the pump 310 when the valve 350 is in the first position “ [symbol] ”. The second directional flow control valve 370 is set to a first position “ [symbol] ” that allows air sucked by the probe 340 into the second branch 314b of the vacuum line 314 to flow into the first branch 314a of the vacuum line 314. The third exchange valve 360 is set to a first position “↑” that allows air introduced into the first branch 314a of the vacuum line 314 to flow into the particle counter 320.

Referring to FIG. 15, the pump 310 and the particle counter 320 begin operating (S310 and S300) when power is supplied to the sampling apparatus 300. As a result, air is sucked through the first filter 352 by the vacuum created by the pump 310 and is thus filtered by the first filter 352 (S380). The filtered air is introduced to the pump 310 through the vacuum line 314 by the first exchange valve 350 set at the first position “ [symbol] ” (S390). Air that has been introduced to the pump 310 is forced to the probe 340 through the exhaust line 312 by the pump 310. The air is filtered and purified by the second filter 372 (S320). The purified air is blown out of the probe 340 and, at the same time, air is sucked into the probe 340 (S330). The air issuing from the probe 340 may be directed onto a surface of the object 530 to dislodge particles from the surface and, in this case, air containing the particles is sucked into the probe 340 (S330). Alternatively, the air may be simply blown out of the probe 340, and air containing particles suspended in the environment in which the probe is located is sucked into the probe 340.

The integral pump of the particle counter 320 also acts (S360) to draw air through the probe 340 (S330). Air flowing from the probe 340 into the second branch 314b of the vacuum line is directed into the first branch 314a by the second flow directional control valve 370 (S340). The air introduced into the first branch 314a of the vacuum line 314 is directed to the particle counter 320 by the third flow directional control valve 360 (S350). The particle counter 320 detects particles contained in the air, determines the size of the particles, and counts the number of particles of each size (S370).

Referring to FIG. 16, the first flow directional control valve 350 is set to a second position “↑”, the second flow directional control valve 370 is set to a second position “←”, and the third flow directional control valve 360 is set to a second position “ [symbol] ” to place the sampling apparatus 300 in the particle adsorption mode. The paths along which air is confined to flow in the sampling apparatus 300 when the flow directional control valves 350, 360 and 370 are at their respective positions correspond to the symbols above in FIG. 16.

Referring to FIG. 17, power is supplied to the pump 310 (S490). As a result, air is forced through the exhaust line 312 and is purified by the second filter 372 (S420). The purified air is blown out through the probe 340, and air containing particles is sucked into the probe 340 (S430). The air containing particles is directed (S540) from the second branch 314b of the vacuum line 314 to the adsorption chamber 330 by the second exchange valve 370. The particles are trapped inside the chamber of the adsorption device 330, and the air that has passed through the chamber is directed (S480) to the pump 310 by the first flow directional control valve 350. Also, the air may be directed through flow meter 380 (S460) before it flows into the pump 310. In this case, the flow rate discerned by the flow meter 380 may be used to control the speed of the pump 310, i.e., regulate the flow rate of air in the sampling apparatus 300. In any case, the air fed to the pump 310 is pumped into the exhaust line 312, is purified in the exhaust line 312 by the second filter 372 (S420) and is blown out through the probe 340 (S430).

The particle counter 320 may also be operated at this time (S400) by turning on (S500) the pump of the particle counter 320. Thus, air is induced through the third filter 362 by the vacuum created by the particle counter 320, such that the air is purified by the third filter 362 (S510). The purified air is directed to the particle counter 320 by the third flow directional control valve 360 (S520).

As described above, the present invention determines not only the number of particles of each size, but also can collect the particles so that the particles can be examined to determine their shape and/or composition. Therefore, the present invention can be used to trace the particles to their source.

Finally, although the present invention has been described in connection with the preferred embodiments thereof, it is to be understood that the scope of the present invention is not so limited. On the contrary, various modifications of and changes to the preferred embodiments will be apparent to those of ordinary skill in the art. Thus, changes to and modifications of the preferred embodiments may fall within the true spirit and scope of the invention as defined by the appended claims.

What is claimed is:

1. A particle adsorption device comprising:
a chamber having an inlet and an outlet through which air can pass into and out of the chamber along an air flow path extending through a space within the chamber;
an adsorption plate;
a support disposed inside the chamber and configured to support the adsorption plate such that a surface of the plate is exposed to air entering the chamber through the inlet, whereby the surface of the adsorption plate will adsorb the air and thereby trap particles contained in the air on the surface; and
at least one porous plate disposed in the air flow path within the chamber, pores of the at least one porous plate being arranged to stabilize air introduced into the chamber through the inlet at a given rate.

2. The particle adsorption device of claim 1, wherein the at least one porous plate comprises a first porous plate disposed to one side of the adsorption plate and a second porous plate disposed to the other side of the adsorption plate.

3. The particle adsorption device of claim 2, further comprising a third porous plate disposed on an opposite side of the first porous plate from the adsorption plate, pores of the third porous plate being arranged to distribute air entering the inlet of the chamber such that the air is not concentrated on a predetermined region of the adsorption plate.

4. The particle adsorption device of claim 3, wherein the pores of the third porous plate include a plurality of first through-holes each having the same diameter and a plurality of second through-holes each having the same diameter, the diameter of the first through-holes being smaller than the diameter of the second through-holes.

5. The particle adsorption device of claim 4, wherein the first through-holes are concentrated at a central portion of the third porous plate.

6. The particle adsorption device of claim 1, wherein the chamber includes a chamber body having an opening in a portion thereof, and a cover sealing the opening.

7. The particle adsorption device of claim 6, wherein the cover includes a projection extending into the chamber body, the projection having a frustum-shaped concavity therein constituting a portion of the air flow path within the chamber.

8. A sampling apparatus comprising:
a particle counter having a particle detector operative to detect particles of a certain size in air and count the number of particles;
a particle adsorption device including a chamber having an inlet and an outlet through which air can pass into and out of the chamber along an air flow path extending through a space within the chamber,
an adsorption plate, and
a support disposed inside the chamber and configured to support the adsorption plate such that a surface of the plate is exposed to air entering the chamber through the inlet, whereby the surface of the adsorption plate will adsorb the air and thereby trap particles contained in the air on the surface; and
air lines connecting the chamber of the particle adsorption device to the particle detector of the particle counter.

9. The sampling apparatus of claim 8, wherein the particle adsorption device further includes at least one porous plate disposed in the air flow path within the chamber, pores of the at least one porous plate being arranged to stabilize air introduced into the chamber through the inlet at a given rate.

10. The sampling apparatus of claim 9, wherein the particle adsorption device includes another porous plate disposed in the air flow path between the inlet of the chamber and the adsorption plate, pores of the another porous plate being arranged to distribute air entering the inlet of the chamber such that the air is not concentrated on a predetermined region of the adsorption plate.

11. The sampling apparatus of claim 10, wherein the pores of another porous plate include a plurality of first through-holes concentrated at a central portion of the another porous plate and each having the same diameter, and a plurality of second through-holes each having the same diameter, the diameter of the first through-holes being smaller than the diameter of the second through-holes.

12. The particle sampling device of claim 9, wherein the chamber includes a chamber body having an opening a portion thereof, and a cover sealing the opening, the cover having a projection extending into the chamber body, the projection having a frustum-shaped concavity therein constituting a portion of the air flow path within the chamber.

13. A sampling apparatus comprising:
a pump having an intake side at which the pump creates a vacuum and an exhaust side at which air is forced from the pump;
an exhaust line extending from the exhaust side of the pump;
a vacuum line leading to the intake side of the pump;
a probe connected to the vacuum line at an end of the vacuum line such that air can be sucked into the vacuum line through the probe when the pump is running; a particle counter connected to the vacuum line, the particle counter having a particle detector operative to detect particles of a certain size in air and count the number of particles; and
a particle adsorption device including a chamber having an inlet and an outlet through which air can pass into and out of the chamber along an air flow path extending through a space within the chamber, the chamber being connected to the vacuum line at both the inlet and outlet thereof,
an adsorption plate, and
a support disposed inside the chamber and configured to support the adsorption plate such that a surface of the plate is exposed to air entering the chamber through the inlet, whereby the surface of the adsorption plate will adsorb the air and thereby trap particles contained in the air on the surface.

14. The sampling apparatus of claim 13, wherein the particle detector and the chamber of the particle adsorption device are both disposed in-line with the vacuum line between the probe and the intake side of the pump.

15. The sampling apparatus of claim 13, wherein the vacuum line has a first branch, and a second branch extending from the probe, the first and second branches diverging between the probe and the inlet of the chamber of the particle adsorption device, and the particle counter being disposed at the end of the second branch of the vacuum line.

16. The sampling apparatus of claim 15, further comprising a first directional flow control valve disposed in the vacuum line between the outlet of the chamber of the particle adsorption device and the intake side of the pump, and a second directional flow control valve disposed in the vacuum line at the location at which the first and second branches of the vacuum line diverge, the first directional flow control valve movable between a first position at which it closes the vacuum line between the outlet of the chamber of the particle adsorption device and the intake side of the pump and a second position at which it opens the vacuum line between the outlet of the chamber of the particle adsorption device and the intake side of the pump, and the second directional flow control valve movable between a first position at which it opens the second branch of the vacuum line to the first branch while closing the vacuum line between the probe and the chamber of the particle adsorption device and a second position at which it opens the vacuum line between the inlet of the chamber of the particle adsorption device and the probe while closing off the second branch of the vacuum line from the first branch.

17. The particle sampling apparatus of claim 16, wherein each of the flow directional control valves is a 3-way solenoid valve.

18. The particle sampling apparatus of claim 16, further comprising a filter connected to the vacuum line through the first flow directional control valve, wherein the first flow directional control valve opens the vacuum line between the filter and the intake side of the pump when it is in the first position thereof.

19. The sampling apparatus of claim 16, further comprising:
a third flow directional control valve disposed in the first branch of the vacuum line, the third flow directional control valve movable between a first position at which it opens the first branch of the vacuum line between the second flow directional control valve and the particle detector and a second position at which it closes opens the first branch of the vacuum line between the second flow directional control valve and the particle detector.

20. The particle sampling apparatus of claim 19, further comprising a filter connected to the first branch of the vacuum line through the second flow directional control valve, wherein the second flow directional control valve opens the first branch of the vacuum line between the filter and the second flow directional control valve when it is in the second position thereof.

21. The particle sampling apparatus of claim 19, wherein the second flow directional control valve is a 3-way solenoid valve.

22. The particle sampling apparatus of claim 13, further comprising a filter disposed in the exhaust line between the exhaust side of the pump and the probe.

23. The particle sampling apparatus of claim 13, wherein an end of the exhaust line is connected to the probe.

24. The particle sampling apparatus of claim 22, wherein an end of the exhaust line is connected to the probe.

25. The particle sampling apparatus of claim 13, wherein the probe is electrically connected to the particle detector so that the particle detector operates when air is flowing through the probe operates and the particle counter stops operating when no air is flowing through the probe.

26. The sampling apparatus of claim 13, wherein the particle adsorption device further includes at least one porous plate disposed in the air flow path within the chamber, pores of the at least one porous plate being arranged to stabilize air introduced into the chamber through the inlet at a given rate.

27. The sampling apparatus of claim 26, wherein the particle adsorption device includes another porous plate disposed in the air flow path between the inlet of the chamber and the adsorption plate, pores of the another porous plate being arranged to distribute air entering the inlet of the chamber such that the air is not concentrated on a predetermined region of the adsorption plate.

28. The sampling apparatus of claim 26, wherein the pores of another porous plate include a plurality of first through-holes concentrated at a central portion of the another porous plate and each having the same diameter, and a plurality of second through-holes each having the same diameter, the diameter of the first through-holes being smaller than the diameter of the second through-holes.

29. The particle sampling device of claim 26, wherein the chamber includes a chamber body having an opening a portion thereof, and a cover sealing the opening, the cover having a projection extending into the chamber body, the projection having a frustum-shaped concavity therein constituting a portion of the air flow path within the chamber.

30. A method for use in monitoring a manufacturing environment for potential contamination, comprising:
collecting a sample of air using suction;
detecting particles of a certain size in the sample of air and counting the number of particles;
adsorbing air from the sample by passing the air over an adsorbent medium to thereby trap particles in the air on a surface of the medium; and
analyzing the particles trapped on the surface of the medium.

31. The method of claim 30, wherein the adsorbing of air from the sample and the detecting of the particles in the sample of air are carried out on the same body of air in the sample.

32. The method of claim 30, wherein the adsorbing of air from the sample is carried out after the particles in the air are detected for counting their number.

33. A method for use in monitoring a manufacturing environment for potential contamination, comprising:
drawing air into and through a probe;
directing air that is drawn through the probe to a particle counter that detects particles of a certain size and counts the number of particles; and
directing air that is drawn through the probe over the surface of an adsorbent medium supported in a hermetic chamber of a particle adsorption device so that air is adsorbed by the medium to thereby trap particles in the adsorbed air on the surface of the medium.

34. The method of claim 33, wherein air is drawn in through the probe by creating a vacuum using a pump.

35. The method of claim 34, wherein the air drawn in through the probe is directed sequentially from one of the chamber of the particle detection device and the particle detector to the other of the particle detection device and the particle detector.

36. The method of claim 34, wherein air drawn in through the probe using the pump is selectively directed to the chamber of the particle detection device and the particle detector.

37. The method of claim 36, further comprising drawing air into the particle detector of the particle counter using a pump of the particle counter while air is being selectively directed from the probe to the chamber of the particle detection device.

38. The method of claim 36, further comprising blowing air out through the probe and onto the surface of an object using the pump while air is being drawn into the probe using the pump, whereby the air blown out of the probe is to dislodge particles from the surface of the object.

39. The method of claim 38, further comprising purifying the air before it is blown out through the probe.

40. The method of claim 33, further comprising removing the adsorbent medium from the hermetic chamber and analyzing the particles trapped on the surface of the medium.
